(19) United States
(12) Patent Application Publication
(10) Pub. No.: US 2007/0221098 A1
(43) Pub. Date: Sep. 27, 2007

(54) METHYL STARCH ETHERS IN MINERAL BUILDING MATERIALS

(75) Inventors: Peter Wolbers, Walsrode (DE); Karsten Bohme, Walsrode (DE); Roland Bayer, Walsrode (DE)

Correspondence Address: CONNOLLY BOVE LODGE & HUTZ, LLP, P O BOX 2207, WILMINGTON, DE, 19899, US

(73) Assignee: Wolff Cellulosics GmbH & Co. KG, Walsrode (DE)

(21) Appl. No.: 11/689,604

(22) Filed: Mar. 22, 2007

(30) Foreign Application Priority Data
Mar. 24, 2006 (DE) 10 2006 013 786.8

(51) Int. Cl. C08B 35/04

(52) U.S. Cl. 106/656; 536/111

(57) ABSTRACT

The present invention relates to the use of methylated starches in mineral building materials.

### RELATED APPLICATIONS

This application claims benefit to German Patent Application No. 10 2006 013 786.8 filed Mar. 24, 2006, which is incorporated by reference in its entirety for all useful purposes.

### BACKGROUND OF THE INVENTION

1. Field of Invention

The present invention relates to the use of methylated starch in mineral building materials.

2. Background of the Invention

Processes for modifying starches to produce the corresponding ethers or esters are known per se in the art and are described, for example, in O. B. Wurzburg, Modified Starches: Properties and Uses, CRC Press Inc., Boca Raton, Fla., Chapters 4 to 6. A preferred modifying reaction is ether formation by reaction with alkylene oxides, preferably propylene oxide.

The methylation of starch to give methyl starch ethers is adequately known and is typically effected by reaction with methyl halide (DE-A 290 00 73) or dimethyl sulphate (DD 54684).

Starch ethers are already used in the field of mineral building materials such as gypsum plaster, cement, plasters and renders or tile adhesives. The starch ethers used here are essentially the hydroxyalkyl derivatives, which may also be used in combination with cellulose derivates (GB-A 1085033, EP-A 530 768, EP-A 955 277, EP-A 117 431, EP-A 773 198, EP-A 824 093, EP-A 816 299).

U.S. Pat. No. 4,654,085 discloses the use of hydroxypropylated starch ethers as additives for cement-containing systems. A mixture of cellulose ethers, starch ethers and polyacrylamides is used here. As starch ethers, mention is made in nonspecific lists of methyl starch, ethyl starch, propyl starch, hydroxyalkyl starch (HPS, HES) and also their mixed ethers. Preference is given to hydroxypropyl starch ethers.

However, in the field of tile adhesives in particular, such building materials based on hydroxypropyl starch ethers have initial strengths and setting times which are in need of improvement.

### SUMMARY OF THE INVENTION

It was therefore an object of the present invention to provide mineral building material compositions, preferably tile adhesives, which have an improved setting behaviour and higher initial strengths and can thus be employed better and more flexibly in industrial practice.

This object was achieved by the use of pure methyl starch ethers and/or mixed ethers of starch having methyl ether and further alkyl ether and/or hydroxyalkyl ether groups.

The invention provides building material compositions containing a starch ether component which contains at least methyl starch ether and/or mixed ethers of starch having methyl ether and further alkyl ether and/or hydroxyalkyl ether groups.

### DETAILED DESCRIPTION OF THE INVENTION

The invention provides building material compositions containing a starch ether component which contains at least methyl starch ether and/or mixed ethers of starch having methyl ether and further alkyl ether and/or hydroxyalkyl ether groups.

Those skilled in the art will be familiar with the term “building material compositions”. For the purposes of the present invention, the term preferably refers to minerally bonded or dispersion-bonded systems such as manually and mechanically applied plasters and renders, e.g. ones based on gypsum plaster, hydrated lime or cement, mortars, tile adhesives, gunned concrete compositions, floor levelling compositions, cement and lime-sand extrudates, joint fillers and tile grout. These are particularly preferably cement-containing, CaSO₄-containing and lime-containing systems of the abovementioned type, very particularly preferably tile adhesives.

Methyl starch ethers are the methylation products obtained by reaction of starch with methylation reagents such as methyl halides or dimethyl sulphate.

Mixed ethers of starch having methyl ether and further alkyl ether and/or hydroxyalkyl ether groups are starch derivatives as can be obtained by methylation and prior, simultaneous or subsequent alkylation and/or hydroxyalkylation.

In the case of alkylation during the preparation of the mixed ethers, preference is given to using alkyl halides such as ethyl chloride. In the case of hydroxyalkylation, alkylene oxides such as ethylene oxide or propylene oxide are preferably used.

As starting material, it is possible to use all starch sources know to those skilled in the art. Preference is given to using starches which have an amylose content of less than 20% by weight, preferably less than 10% by weight, particularly preferably less than 5% by weight and very particularly preferably less than 2% by weight, based on the total amount of starch.

The amylose content of the starch is usually determined by UV/VIS measurements on starch-iodine inclusion complexes. This is a routine method which is known per se to those skilled in the art.

Methyl starches and their mixed ethers can be prepared by etherification of starches using etherifying agents known per se, e.g. dimethyl sulphate or methyl chloride in the presence of bases such as NaOH.

In the case of the mixed ethers, alkylene oxide such as ethylene oxide or propylene oxide is additionally added.

To avoid oxidative degradation, the oxygen is advantageously removed from the reaction mixture by evacuation and flushing with nitrogen.

The degree of substitution (DS) of the product is controlled via the amount of base, preferably sodium hydroxide, used. NaOH can be used as aqueous solution or in solid form NaOH prills or flakes).

Since the etherifying reagents are generally gaseous under the reaction conditions for the etherification, the reaction is advantageously carried out in an optionally stirred autoclave or pressure reactor.

In addition to the abovementioned reactants, inert suspension media such as isopropanol or dimethyl ether can also be used.

The reactants can be introduced in any order, over any period of time and either in their entirety or divided into a plurality of steps.

The reaction temperature is typically from 45° C. to 140° C., preferably from 50° C. to 80° C., particularly preferably from 50° C. to 65° C.

The reaction times until the desired degree of etherification is reached are typically from 30 to 400 minutes, preferably from 30 to 300 minutes.

After the reaction is complete, the starch ethers are suspended in an inert suspension medium, e.g. acetone, and neutralized by means of an acid. The starch ethers obtained in this way are subsequently dried and, if appropriate, milled.

The methyl starch ethers or the corresponding mixed ethers typically have a degree of substitution (DS) based on the methylation from 0.1 to 3, preferably from 0.15 to 2.0, particularly preferably from 0.2 to 1.5 and very particularly preferably from 0.2 to 0.8.

The methyl starch ethers or the corresponding mixed ethers typically have a degree of substitution (DS) based on the hydroxyalkylation from 0.01 to 5, preferably from 0.05 to 2, particularly preferably from 0.1 to 1.

To determine the degree of substitution, the starch ether is reacted with hot, concentrated hydroiodic acid (Zeisel cleavage) and the resulting alkyl iodides and alkylenes are separated and analyzed by gas chromatography.

The starch ethers of the abovementioned type which are used according to the invention preferably have viscosities at 25° C. measured by means of a Brookfield rotational viscometer at 100 rpm in 5% strength by weight aqueous solution of from 100 to 6000 mPas, particularly preferably from 150 to 5500 mPas, very particularly preferably from 500 to 5100 mPas.

The invention further provides starch ethers which have methyl ether groups and a viscosity corresponding to the abovementioned ranges.

They are preferably based on starches having the abovementioned maximum amounts of amylose.

In the building material compositions of the invention, the above-described methyl starch ethers or mixed ethers used according to the invention are present in amounts of from 0.001 to 20% by weight, preferably from 0.001 to 5% by weight, based on the total dry composition.

In a preferred embodiment, only starch ethers of the abovementioned type having methyl ether and optionally alkyl ether and/or hydroxyalkyl ether groups are present in the starch ether component in the building material compositions of the invention.

Apart from the starch ethers used according to the invention, the building material compositions can also contain cellulose derivatives such as methyl celluloses, ethyl celluloses, hydroxypropyl methyl celluloses, hydroxyethyl methyl celluloses, hydroxypropyl celluloses, hydroxyethyl celluloses.

Furthermore, the building material compostions can contain additives and/or modifiers. These can be, for example, hydrocolloids, polymer dispersion powders, antifoams, swelling agents, fillers, low-density additives, polyacrylates, polyacrlyamides, hydrophobicizing agents, air entraining agents, synthetic thickeners, dispersants, plasticizers, retarders, accelerators or stabilizers. Furthermore, fillers such as silica sand, dolomite, calcareous sandstone, calcium sulphate dihydrate are also suitable as additives and/or modifiers.

The invention further provides shaped bodies and structures obtainable using the building material compositions of the invention.

### EXAMPLES

The viscosities were measured using a Brookfield rotational viscometer at 100 rpm and a temperature of 25° C.

### Example 1

### Preparation of methyl starch ethers

1.5 mol of waxy maize starch were placed in a 5 l stirring autoclave and made inert 3 times by evacuation and admission of nitrogen gas. 0.855 mol of a 50% strength by weight sodium hydroxide solution and 8.73 mol of methyl chloride were subsequently introduced into the autoclave and the mixture was stirred for 30 minutes at a temperature of 25° C. The mixture was then heated to 60° C. over a period of 30 minutes and allowed to react at this temperature for 150 minutes. After removal of unreacted methyl chloride, the starch ether was taken out and neutralized with formic acid in acetone, dried and milled. The starch ether, which was in the form of a white powder, had a DS based on the methyl ether groups of 0.52 and a viscosity of a 5% strength by weight solution in water (V5 viscosity) of 2500 mPas at 25° C.

### Example 2

### Preparation of methyl hydroxyethyl starch ethers

1.5 mol of waxy maize starch were placed in a 5 l stirring autoclave and made inert 3 times by evacuation and admission of nitrogen gas. 0.9 mol of a 50% strength by weight sodium hydroxide solution and 8.73 mol of methyl chloride were subsequently introduced into the autoclave and the mixture was stirred for 30 minutes at a temperature of 25° C. 1.5 mol of ethylene oxide were introduced and the mixture was then heated to 60° C. over a period of 30 minutes and allowed to react at this temperature for 300 minutes. After removal of unreacted methyl chloride and ethylene oxide, the starch ether was taken out and neutralized with formic acid in acetone, dried and milled. The starch ether, which was in the form of a white powder, had a DS based on the methyl ether groups of 0.56, an MS based on the hydroxyalkyl groups of 0.7 and a viscosity of a 5% by weight strength solution in water (V5 viscosity) of 4300 mPas at 25° C.

### Examples 3 to 6

### Preparation of methyl hydroxyvropyl starch ethers

4 mol of waxy maize starch were placed in a 5 l stirring autoclave and made inert 3 times by evacuation and admission of nitrogen gas. 2.4 mol of a 50% strength by weight sodium hydroxide solution, 17.87 mol of dimethyl ether and 6.96 mol of methyl chloride were then introduced into the autoclave and the mixture was stirred for 30 minutes at a temperature of 25° C. 3.2 mol of propylene oxide were introduced and the mixture was then heated to 50° C. over a period of 30 minutes. After a reaction time of 240 minutes at this temperature, the mixture was heated to 70° C. over a period of 40 minutes and allowed to react for a further 30 minutes at this temperature. After removal of unreacted methyl chloride and propylene oxide, the starch ether was taken out and neutralized with formic acid in acetone, dried and milled. The starch ether, which was in the form of a white powder, had a DS based on the methyl ether groups of 0.21, an MS based on hydroxyalkyl groups of 0.2 and a viscosity of a 5% strength by weight solution in water (V5 viscosity) of 968 mPas at 25° C.

All syntheses were carried out by the same procedure used in the amounts shown in Table 1.

| | Starch | MCl | PO | DS | MS | V 5 | Suspension medium | |
|---|---|---|---|---|---|---|---|---|
| Ex. | [mol] | [mol] | [mol] | (M) | (HP) | [mPas] | [mol] | |
| 3 | 4.0 | 4.0 | 3.2 | 0.35 | 0.33 | 778 | Isopropanol | 12.3 |
| 4 | 4.0 | 6.96 | 3.2 | 0.21 | 0.20 | 968 | Dimethyl | 17.8 |
| | | | | | | | ether | |
| 5 | 4.0 | 23.4 | 3.2 | 0.70 | 0.18 | 663 | | |
| 6 | 4.0 | 4.0 | 3.2 | 0.16 | 0.19 | 518 | Dimethyl | 21.1 |
| | | | | | | | ether | |

### Use tests

The methyl starch ethers prepared in Examples 1 to 6 were compared with a commercial, crosslinked hydroxypropyl starch ether.

The tests were carried out on a tile adhesive having the following composition:
35.0% by weight of Milke cement CEM 152.5R (Anneliese-Zement, Geseke, DE) of 06/05
31.1% by weight of silica sand F36 (Quarzwerke Frechen, DE) of 11/04
31.5% by weight of silica sand FH31 sieved off <0.5 mm (Quarzwerke Frechen, DE) of 11/04
2.0% by weight of Vinnapas RE 5028N (Wacker Polymer Systems, Burghausen, DE)
0.40% by weight of Arbocell BWW40 (Rettenmaier, Holzmühlen, DE) of 03/05
0.45% by weight of a mixture of 75% by weight of modified methyl cellulose and 25% by weight of the starch ether to be examined.

The modified methyl cellulose used was an MHEC 15000 PF having a DS (M) of 1.8 and an MS (HE) of 0.15 from Wolff Cellulosics GmbH (Walsrode, DE).

The determinations are carried out at an atmospheric humidity of 50±5%, a temperature of 23±2° C. and an air movement over the material to be tested of <0.2 m/s.

The amounts of dry substance indicated were weighed into a plastic bag and homogeneously mixed manually by repeated shaking for about 5 minutes, with any cement lumps being crushed beforehand.

The mortar mixture was produced in accordance with the EN Standard 1348, Section 7. For this purpose, the required amount of water was placed in the mixing trough of a Toni mixer and 1.5 kg of the dry tile adhesive was sprinkled into the liquid over a period of about 15 seconds. The material was then stirred for about 90 seconds with occasional wiping of the stirrer blade and subsequently allowed to mature for 10 minutes. The material was then stirred up again for 15 seconds.

3 minutes after the end of stirring, the wet mortar was introduced into the measuring pot by means of a spoon. The consistency was determined by means of a Brookfield viscometer and a Helipath spindle: T-F; 100 rpm. The mean value of 7 measurements is reported in Pas.

In the determination of the slip resistance of a tile adhesive, the tile adhesive was combed onto a slippage plate [height: 220 mm; 200×250 mm material PVC] [comb applicator 4×4 mm]. The maximum weight of a tile which was still just held by the adhesive was then determined using a previously weighed tile [stoneware tile 10×10 cm; 200 g] and additional weights [each weight 50 g]. The slip of the tile after 30 s without an additional weight in mm and the maximum tile weight in gram per cm² [g/cm₂] are reported.

The results of the consistency determination and the slip resistance are summarized in Table 2. Owing to the crosslinking of the commercial starch ether, the viscosity increase produced by this starch derivative is the highest. Nevertheless, the uncrosslinked methyl starches surprisingly display comparable low slippage values and high additional weights before the tile begins to slip at low W/S ratios.

In the determination of the open time, the time within which it is possible to lay tiles after a defined time [5/10/15/20/25/30 min] in a combed-on bed of tile adhesive and later take them off again was determined. The wetting of the rear side of the tiles was subsequently assessed. To carry out the test, the tile adhesive was combed on by means of a comb applicator [6×6 mm]. After 5 minutes, the first tile was laid in and loaded with a 2 kg weight for 30 s. Further tiles were subsequently laid in at intervals of 5 minutes and likewise loaded with 2 kg for 30 seconds. After 40 minutes, all tiles were taken off and turned around. The wetting of the rear side of the tiles with tile adhesive was indicated in percent by means of a grid film. The open time reported was the time in minutes for which values of more than 50% of adhesive on the rear side of the tile were found.

Furthermore, the course of setting from mixing of a tile adhesive with water through the commencement of setting to the end of setting. The setting time was determined by penetration of a needle [automatic Vicat penetrometer] into the tile adhesive. To carry out the tests, the adhesive was mixed with water and then introduced with gentle rodding into a plastic cup [internal diameter: 93 mm, h=38 mm] so as to be free of air bubbles. The surface was subsequently struck flat without pressure by means of a broad spatula using a sawing motion. Before the sample surface was covered with paraffin oil, the outer edge was painted with a thickness of about 0.5 cm of tile adhesive to stop the oil from running down. The oil prevents skin formation and the adhesion of tile adhesive material to the test needle. The setting time was then determined as the period of time within which the penetration depth has decreased from 36 mm at the beginning to 2 mm. The results of the open time and the setting behaviour are summarized in Table 2. At a comparable open time of the tile adhesives, the setting of the tile adhesives to which methyl starches have been added commences significantly earlier and occurs over a shorter time.

The determination of the adhesion strength after 24 hours and after 7 days storage under standard conditions of temperature and humidity was carried out in accordance with EN 1348.

The shortening of the setting time for the tile adhesives to which methyl starches have been added also improves the adhesive pull strengths after 24 hours. These are significantly improved compared to a commercial, crosslinked HPS, which allows earlier loading of the materials.

| | Comparison | Example 1 | Example 4 |
|---|---|---|---|
| Starch ether | HPS | MS | MHPS |
| Amount of mixture with | 0.45 | 0.45 | 0.45 |
| MC used [% by weight] | | | |
| Water/solids [% by weight] | 0.305 | 0.29 | 0.285 |
| Brookfield viscosity @ 25° C. | 462 | 420 | 455 |
| [Pas] | | | |
| Density [g/cm³] | 1.58 | 1.58 | 1.58 |
| Slippage test | | | |
| After 30 s [mm] | 0.6 | 0.8 | 0.6 |
| Additional weight until | 200 | 150 | 150–200 |
| slippage occurs [g] | | | |
| Maximum tile weight [g/cm²] | 3 | 2.5 | 2.5–3.0 |
| Open time [%] | | | |
| After 5 min | 100 | 100 | 100 |
| After 10 min | 95 | 95 | 100 |
| After 15 min | 95 | 95 | 100 |
| After 20 min | 95 | 95 | 75 |
| After 25 min | 95* | 90* | 60* |
| After 30 min | 85 | 75 | 70 |
| Setting behaviour | | | |
| Commencement [min] | 893 | 635 | 575 |
| End [min] | 1036 | 717 | 689 |
| Duration [min] | 143 | 82 | 114 |
| Adhesive pull strengths | | | |
| 24 h standard conditions | 0.27 | 0.7 | 0.4 |
| of temperature and | | | |
| humidity [N/mm²] | | | |
| 7 days standard conditions | 1.2 | 1.5 | 1.4 |
| of temperature and humidity | | | |
| [N/mm²] | | | |

*Commencement of skin formation

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept

1. A building material composition which comprises a starch ether component which contains at least methyl starch ether and/or mixed ethers of starch having methyl ether and further alkyl ether and/or hydroxyalkyl ether groups.

2. The building material composition according to claim 1, wherein said composition contains no further starch-based compounds apart from the starch ether component.

3. The building material composition according to claim 1, wherein the building material compositions are minerally bonded or dispersion-bonded systems.

4. The building material composition according to claim 3, wherein the minerally bonded systems are based on gypsum, cement and hydrated lime, such as manually and mechanically applied plasters, mortars, tile adhesives, gummed concrete compositions, cement and limesand extrudates, joint fillers or tile grouts.

5. The building material composition according to claim 3, wherein the dispersion-bonded systems are based on waterborne copolymers, such as ready to use plasters, tile adhesives, joint fillers and paints.

6. The building material composition according to claim 1, wherein the methyl starch ethers and/or mixed ethers of starch are based on types of starch which have an amylose content of less than 20% by weight, based on the total amount of starch.

7. The building material composition according to claim 1, wherein the compounds of the starch ether component have a degree of substitution (DS) based on the methylation of from 0.1 to 3.

8. The building material composition according to claim 1, wherein the starch ether component have a degree of substitution (MS) based on the hydroxyalkylation of from 0.01 to 5.

9. The building material composition according to claim 1, wherein the compounds of the starch ether component as a 5% strength by weight aqueous solution have a viscosity at 25° C. measured by means of a Brookfield rotational viscometer at 100 rpm of from 100 to 6000 mPas.

10. The building material composition according to claim 1, wherein the compounds of the starch ether component are present in the building material compositions in amounts of from 0.001 to 20% by weight, based on the total dry composition.

11. The building material composition according to claim 5, wherein the methyl starch ethers and/or mixed ethers of starch are based on types of starch which have an amylose content of less than 10% by weight, based on the total amount of starch.

12. The building material composition according to claim 11, wherein the methyl starch ethers 5 and/or mixed ethers of starch are based on types of starch which have an amylose content of less than 2% by weight, based on the total amount of starch.

13. The building material composition according to claim 12, wherein the compounds of the starch ether component have a degree of substitution (DS) based on the methylation of from 0.2 to 1.5.

14. The building material composition according to claim 13, wherein the compounds of the starch ether component have a degree of substitution (DS) based on the methylation of from 0.2 to 0.8.

15. The building material composition according to claim 14, wherein the starch ether component have a degree of substitution (MS) based on the hydroxyalkylation of from 0.1 to 1.

16. The building material composition according to claim 15, wherein the compounds of the starch ether component as a 5% strength by weight aqueous solution have a viscosity at 25° C. measured by means of a Brookfield rotational viscometer at 100 rpm of from 500 to 5100 mPas.

17. The building material composition according to claim 16, wherein the compounds of the 20 starch ether component are present in the building material compositions in amounts of from 0.001 to 5% by weight, based on the total dry composition.

18. Starch ethers which comprise methyl ether groups and whose 5% strength by weight aqueous solution has a Brookfield viscosity of from 900 to 5100 mPas, measured by means of a rotational viscometer at 100 rpm at 25° C.

19. Starch ethers according to claim 18, wherein the starch ethers have an amylose content of less than 10% by weight, based on the total starch ether.

20. Shaped bodies and structures which comprise the building material composition according to claim 1.
